(19) United States
(12) Patent Application Publication
(10) Pub. No.: US 2014/0331941 A1
(43) Pub. Date: Nov. 13, 2014

(54) ELECTRIC DETERRENT DEVICE

(71) Applicant: Bird Barrier America, Inc., Carson, CA (US)

(72) Inventor: Cameron A. RIDDELL, Carson, CA (US)

(73) Assignee: Bird Barrier America, Inc., Carson, CA (US)

(21) Appl. No.: 14/267,797

(22) Filed: May 1, 2014

Related U.S. Application Data
(60) Provisional application No. 61/822,220, filed on May 10, 2013.

(51) Int. Cl. A01M 29/26

(52) U.S. Cl. CPC A01M 29/26
USPC 119/713

(57) ABSTRACT

An electric deterrent device and methods for installing and producing an electric deterrent device for delivering an electric shock to an animal, pest, or bird to be deterred, having the components of an elongated flexible non-conductive base to which the electrically conductive elements are coupled.

### CROSS-REFERENCE TO RELATED APPLICATION

This application claims the benefit of U.S. Provisional Application No. 61/822,220, filed May 10, 2013, the entirety of which is incorporated herein by reference.

### FIELD

This patent document relates in general to an electric deterrent device that delivers an electric shock to animals or pests that come into contact with it. In particular, this patent document pertains to such devices that are adapted for use as bird deterrent devices.

### BACKGROUND

Electricity was first put to commercial and residential use in the United States in the late 1800's, to solve the age-old problem of darkness. Ever since, the ability of electrical current to deliver an electric shock to a person or animal has been recognized. Shortly thereafter, the non-lethal applications of electricity for use in encouraging the behavior of animals was commercially implemented. The electric cattle prod is perhaps the best known of those devices. Today, however, electricity is used in many ways with animals. As just a few examples, electric fences are used to keep farm animals in and predators out, and dog trainers use electrical stimulus in dog collars to assist with dog training.

An age-old problem that has been perplexing mankind since long before the discovery and harnessing of electricity is the propensity of pests in general, but particularly birds, to land in areas where their human neighbors would prefer they did not. An incredible array of devices have been used to dissuade birds from landing or roosting in areas undesirable to humans. Metallic spikes, coil or rotating devices, sound-emitting devices, imitation predators, and even real predators, are just a few examples of bird deterrent devices that have been used.

At some point in the evolution of bird deterrent devices lethal and non-lethal electrical shock began to be employed as a bird deterrent. One device of this type is shown in U.S. Pat. No. 4,299,048. In one embodiment, a pair of copper wires connected to a power source are embedded in opposite sides of a cable of appropriate diameter such that when the birds of choice (in this case, starlings) land on the cable, their feet touch both wires, closing the circuit and thereby delivering a lethal shock to the birds.

U.S. Pat. No. 6,283,064 discloses another version of a bird and pest deterrent device in which a pair of crimped copper wires are appropriately spaced apart so that the bird's or other pest's feet will touch both wires, resulting in a short circuit and delivering a shock to the bird or other pest.

Other devices for carrying electric charges for discouraging birds and other pests are described in U.S. Pat. Nos. 3,294,893; 3,366,854; 3,717,802; 4,299,048; and 5,850,808. A common idea to all of these devices is the concept of appropriately spaced-apart electrical contacts which will both be connected by the bird's (or other pest's) feet (or other part of their anatomy) so as to deliver the appropriate electric shock.

U.S. Pat. No. 7,481,021 to Riddell uses a flexible track and replaces the typically-used wire with a braided conductive element that may be sewn to the base. This configuration helps alleviate the problem of the wire separating from its base when the track is bent to fit certain surfaces.

Some other devices and methods are disclosed, for example, in the following: U.S. Pat. Nos. 3,294,893; 3,366,854; 3,622,685; 4,299,048; 4,494,733; 5,031,353; 8,015,747; 8,020,340; 8,286,385; U.S. Publication No. 2013/0042817; and international applications EP 0 592 054; EP 1 314 355, WO 96/08140, WO 95/08915; and WO 2012/040009.

While the existing animal deterrents are useful to a degree, they still suffer from certain drawbacks. Therefore, there exists a need in the art for an improved electrical shock deterrent device that solves or at least alleviates some or all of these problems.

### SUMMARY OF THE EMBODIMENTS

Systems and methods for deterring animals by using electrical animal deterrent devices and systems and methods of installing and manufacturing such electric deterrent devices, and methods of repelling animals, in particular birds, are disclosed and claimed herein.

As described more fully below, the apparatus and processes of the embodiments disclosed permit improved systems and methods for deterring animals by using electrical animal deterrent devices and systems and methods of manufacturing and installing such electric deterrent devices. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed embodiments.

To this end, an electric deterrent device is provided, the electric deterrent device comprising an elongated flexible non-conductive base strand; a first elongated flexible electrically conductive element coupled to the base strand; a second elongated flexible electrically conductive element coupled to the base strand; wherein the first elongated flexible electrically conductive element and the second elongated flexible electrically conductive element extend along the base strand in the longitudinal direction. In some embodiments, the first and second conductive elements do not touch each other while they are wrapped around the base strand. In some embodiments, the elongated flexible non-conductive base strand may be comprised of multiple strands. In some embodiments, the elongated flexible non-conductive base strand may be comprised of multiple non-conductive strands. In some embodiments, the electric deterrent device may be comprised of multiple strands, wherein at least one of the strands is non-conductive, and at least one of the strands is conductive. In some embodiments, the elongated flexible non-conductive base strand may be comprised of multiple strands, wherein at least one of the strands is non-conductive, and at least one of the strands is conductive. In some embodiments, the first elongated flexible electrically conductive element and the second elongated flexible electrically conductive element are attachable respectively to the positive and negative terminals of a power source.

In one form, an electric deterrent device is provided, the electric deterrent device comprising an elongated flexible non-conductive base; a first elongated flexible electrically conductive element coupled to the base; a second elongated flexible electrically conductive element coupled to the base; a third elongated flexible electrically conductive element coupled to the base; and a fourth elongated flexible electrically conductive element coupled to the base; wherein the elongated flexible electrically conductive elements are wrapped around the base in the axial direction. In some embodiments, the conductive elements are evenly spaced apart from each other as they extend along the length of the base such the conductive elements never touch each other.

In one form, an electric deterrent device is provided, the electric deterrent device comprising an elongated flexible non-conductive base; a first elongated flexible electrically conductive element coupled to the base; a second elongated flexible electrically conductive element coupled to the base; wherein the first elongated flexible electrically conductive element and the second elongated flexible electrically conductive element are wrapped around the base in the axial direction. In some embodiments, the first and second conductive elements do not touch each other while they are wrapped around the base. In some embodiments, the first conductive element and the second conductive element are attachable respectively to the positive and negative terminals of a power source. In some embodiments, the electric deterrent device further comprises more than two conductive elements.

In some embodiments, the base is made of a non-conductive material. In some embodiments, the base is elongated. In some embodiments, the base is flexible. In some embodiments, the base is a tube. In some embodiments, the base has a hollow interior space that extends longitudinally along a length of the base, wherein the hollow interior space has openings at each end of the base. In some embodiments, the hollow interior space of the base is filled with an adhesive, a foam, or an aerogel. In some embodiments, the hollow interior space of the base is at least partially filled with an adhesive, a foam, or an aerogel. In some embodiments, portions of the hollow interior space of the base contain an adhesive, a foam, or an aerogel.

In some embodiments, the base is a solid strand with no hollow interior space. In some embodiments, the base is made of multiple strands. In some embodiments, the base is made of a rope. In some embodiments, the base is made of multiple strands twisted together. In some embodiments, the base is made of multiple non-conductive strands. In some embodiments, the base is made of a plurality of strands braided together. In some embodiments, the base is made of a plurality of strands woven together. In some embodiments, the base is a rope. In some embodiments, the base is a twisted rope. In some embodiments, the base is made of a mesh. In some embodiments, the base is made of an inner tube and an outer tube. In some embodiments, the base has a plurality of free spaces along a length of the base and wherein, the free spaces form openings through the base wherein, the openings pass from a top of the base through the base to the opposite side. In some embodiments, an at least a pair of elongated flexible electrically conductive elements are attached to the base by a fastener that extends through at least some of the free spaces of the base.

In some embodiments, the fastener may be made of a non-conductive material. In some embodiments the fastener may be made of a waterproof material, such as plastic, to prevent water-wicking In some embodiments the sewing thread may be made of a waterproof material, such as plastic. In some embodiments, the fastener may be made of a polymer, plastic, vinyl, polyester, cloth, linen, twine, string, wool, cotton, a para-aramid synthetic fiber (such as Kevlar®), or any other suitable material.

In some embodiments, the fastener may be made of a conductive material. In some embodiments, the fastener may be iron, steel, stainless steel, copper, or zinc plated copper. In some embodiments, the sewing thread may be made of a conductive material. In some embodiments, the sewing thread may be made of metal such as iron, steel, stainless steel, copper, or zinc plated copper. In some embodiments, the fastener may be made of an intrinsically conducting polymers, such as for example, polyacetylene, polypyrrole, polyaniline, or their copolymers.

In some embodiments, a conductive element is molded into the base. In some embodiments the conductive element is co-molded into the base. In some embodiments the conductive element is co-extruded into the base.

In some embodiments, the first conductive element comprises an undulating shape. In some embodiments, the first conductive element comprises an undulating shape wherein the valleys of the undulating shape of the conductive element are molded into the elongated flexible non-conductive base. In some embodiments, the first conductive element comprises an undulating shape wherein the peaks of the undulating shape extend out of the elongated flexible non-conductive base.

In other embodiments, the first conductive element may comprise a shape selected from the group of an undulating or wave shape, a sinusoidal shape, a zigzag shape, a curved shape, a jagged or ridged shape, a square shape, a rectangular shape, a box step shape, a shape where the peaks are substantially flat relative to the top of the base strip, or any combination thereof.

In some embodiments, the base is constructed entirely of a non-conductive material. In another embodiment, the elongated base is made primarily of plastic. In another embodiment, the elongated flexible base is made primarily of a flexible plastic material. In another embodiment, the elongated base is made primarily of a rigid material. In yet another embodiment, the elongated base is constructed primarily of polyvinyl chloride. In yet another embodiment, the elongated flexible base is constructed entirely of flexible polyvinyl chloride. In yet another embodiment, the elongated flexible base is constructed entirely of rubber. In some embodiments, the elongated flexible base is constructed entirely of a material selected from the group of neoprene, fluoroelastomer, silicone, natural rubber, buna N (nitrile), buna S (SBR), thermoplastic rubber, synthetic polyisoprene, EPDM and polyurethane.

In some embodiments, the device further comprises a second conductive element. In some embodiments, the device comprises a plurality of conductive elements. In some embodiments, the conductive element is made of metal. In other embodiments, the conductive element is made of multiple strands. In other embodiments, the conductive element is made of a single strand. In some embodiments, the conductive element is the shape of a flat ribbon. In some embodiments, the conductive element is a metal tape. In other embodiments, the conductive element is the shape of a tube. In some embodiments, the conductive element is made of one tube inside of another tube, or an inner tube and an outer tube configuration. In some embodiments, the conductive element is in the shape of a rope. In some embodiments, the conductive element is a twisted rope. In some embodiments, the conductive element is made of smooth strands. In other embodiments, the conductive element is made of a single strand interwoven with itself. In another embodiment, the strands of the conductive element are made of metal. In yet another embodiment, at least one strand of the first conductive element is made of metal, and at least one strand of the first conductive element is made of a non-conductive material. In other embodiments, some of the strands are made of metal and some are not. In some embodiments, the strands are constructed of stainless steel, copper, or zinc plated copper, or a combination thereof. In some embodiments, the conductive element may be a wire. In some embodiments, the conductive element may be a ribbon. In some embodiments, the conductive element may be a sheet. In some embodiments, the conductive element may be a rod. In some embodiments, each elongated flexible electrically conductive element has a plurality of free spaces along a length of the elongated flexible electrically conductive element and wherein, the free spaces form openings through the elongated flexible electrically conductive element wherein, the openings pass from a top of the electrically conductive element toward the base. In some embodiments, the elongated flexible electrically conductive elements are coupled to said flexible elongated non-conductive base by a fastener wherein, the fastener extends through at least one of the free spaces of the conductive element. In some embodiments, the fastener may be stitching, staples, pins, tacs, nails, glue, nuts and bolts, or any combination thereof.

In another embodiment, the conductive element is substantially flat in cross section. In yet another embodiment, the conductive element is substantially round in cross section. In another embodiment, the strands of the conductive element are woven loosely together. In yet another embodiment, the strands of the conductive element are woven tightly together.

In some embodiments, when the base is bent in any direction, the elements are coupled to the base such that the deterrent device can be bent into a curvature radius of less than one inch without permanent deformation of either the base or the conductive elements. In some embodiments, when the base is bent in any direction, the elements are molded with the base such that the deterrent device can be bent into a curvature radius of less than one inch without permanent deformation of either the base or the conductive elements. In some embodiments, when the base is bent in any direction, the elements are fastened to the base such that the deterrent device can be bent into a curvature radius of less than one inch without permanent deformation of either the base or the conductive elements.

In some embodiments, the conductive element is braided. In other embodiments, the conductive element is a mesh. In some embodiments, the conductive element is knitted. In other embodiments, the conductive element is made of interlocking loops. In some embodiments, the conductive element contains at least one free space through the conductive element. In other embodiments, the strands form free spaces within the conductive element, as for example free or open spaces in a braid, mesh, knitted, woven, rope, or interlocking loops configuration of the conductive element.

In some embodiments, the strands are intermittently in contact along the length of the conductive element. In other embodiments, the strands are in repetitive intermittent contact for at least a portion of the length of the conductive element. In some embodiments, the strands may be interwoven to form the conductive element. In other embodiments, the strands may be interwoven together to form the conductive element. In some embodiments, the conductive element may be comprised of a single strand interwoven with itself. In some embodiments, the conductive element may be a sheet. In some embodiments, the conductive element may be a tube.

In some embodiments, the electric deterrent device further comprises an arc suppressor disposed between the first conductive element and the second conductive element. In some embodiments, the arc suppressor is raised above the top surface of the base. In other embodiments, the arc suppressor may comprise a peak, pyramid, or triangular shape. In some embodiments, the arc suppressor is elevated above the top surface of the base. In another embodiment, the arc suppressor comprises an umbrelloid shape, a T-shape, a stemmed inverted U-shape, or a stemmed inverted V-shape. In some embodiments where the conductive elements are wrapped around the base and extend along the length of the base, the arc suppressor extends upward from the base and is disposed between the conductive elements such that it extends along the base substantially parallel to the conductive elements.

In some embodiments, the electric deterrent device comprises an elongated base having a cross section including an outer surface and an inner surface. In yet another embodiment, the cross section of the elongated base has a slit that extends from the outer surface to the inner surface. In another embodiment, the slit also extends longitudinally along the length of the base. In some embodiments, the slit is positioned such that it creates a flap in the base. In some embodiments, the flap is sufficiently flexible to allow it to be bent outward to allow outside access to the inner surface of the base. In some embodiments, the fastener couples the conductive element to the base, wherein the fastener extends from a first connection point on the outer surface of the base to a second connection point on the inner surface of the base. In some embodiments, the fastener further extends to a third connection point, wherein the third connection point is located on the opposite inner surface of the base from the second connection point on the inner surface of the base. In some embodiments, the fastener further extends to a fourth connection point, wherein the fourth connection point is located on the opposite side of the outer surface of the base from the first connection point.

In some embodiments, the cross section includes a center divider bisecting the cross section of the hollow interior space and extending along the longitudinal length of the base.

In some embodiments, the first conductive element and the second conductive element are attachable respectively to the positive and negative terminals of a power source.

In some embodiments the base may contain a single gap that extends along the length of the base. In other embodiments the base may contain a substantially enclosed interior space that extends along the length of the base. In other embodiments the base may contain multiple gaps that extend along the length of the base. In other embodiments the base may contain substantially enclosed interior spaces that extend along the length of the base.

In some embodiments, an at least one void extends along the length of the elongated base. In some embodiments, the void extends along the longitudinal length of the elongated base. In some embodiments, the void is open at the ends of the elongated base. In some embodiments, the void is closed at the ends of the elongated base. In some embodiments, the elongated base comprises a plurality of voids extending perpendicular to the cross section of the elongated base. In some embodiments, the voids may contain an adhesive, an aerogel, or a foam. In some embodiments, the electrical conductors may extend at least partially into the gap. In some embodiments, the electrical conductor may extend at least partially into the at least one void. In some embodiments, the electrical conductor may extend at least partially into a gap. In some embodiments, the base of the electric deterrent device has no gaps and no voids.

In some embodiments, at least a portion of a void may include a low-density material, such as a foam or aerogel. In some embodiments, the conductive element may be comprised of a single strand. In some embodiments, the conductive element may be comprised of a single strand interwoven with itself. In some embodiments, the conductive element may be comprised of a tube. In some embodiments, the conductive element may be comprised of an inner tube and an outer tube. In some embodiments, the conductive element may be comprised of a tube, wherein the tube is further comprised of a single strand. In some embodiments, the conductive element may be comprised of a tube, wherein the tube is further comprised of a single strand interwoven with itself. In some embodiments, the conductive element may be a conductive sheet or ribbon. In some embodiments, the conductive element may be a conductive sheet with no free spaces. In some embodiments, the conductive element may be a conductive tube. In some embodiments, the conductive element may be a conductive rod. In some embodiments, the conductive element may be a conductive wire. In some embodiments, the conductive element may be a conductive tube with additional holes or free spaces around the tube's outer surface extending to the tube's inner surface around the tube's circumference.

In some embodiments, the electric deterrent device may be disposed on tree branches or tree limbs. In some embodiments, the electric deterrent device may be disposed on tree branches or tree limbs such that the device is suspended between the tree branches or tree limbs. In some embodiments, the electric deterrent device may be coupled to the tree branches or tree limbs. In some embodiments, the electric deterrent device may be attached to the tree branches or tree limbs. In some embodiments, the electric deterrent device may be wrapped around tree branches or tree limbs. In some embodiments, the bottom surface of the base may comprise a shape that increases the surface area of the outer surface of the base as compared to a smooth surface. In some embodiments, an adhesive such as glue may be applied to the portions of the outer surface with an increased surface area to increase the bonding strength of the deterrent device when it is applied to an exterior surface such as a tree, tree branches, a building, or other surface on which may be installed. In some embodiments, the outer surface with an increased surface area of the base may comprise ridges. In some embodiments, the ridged pattern may be repeatable shapes. In other embodiments, the outer surface may comprise non-repeating shapes. The ridged outer surface may also be referred to as jagged or toothed. In other embodiments, the outer surface may be corrugated or ribbed. In other embodiments, the outer surface of the device may comprise ridges, channels, grooves, notches, holes, or any combination thereof. In some embodiments, an adhesive such as glue may be applied between the outer surface of the device and a surface exterior to the base such that at least a portion of the adhesive may disposed in any ridges, channels, grooves, notches, holes, or a combination thereof.

In some embodiments, the flexible elongated base is substantially non-conductive. In other embodiments, the elongated base may have varying degrees of flexibility. In other embodiments, the elongated base may be inflexible or substantially rigid. In some embodiments, the base may be referred to as a core.

In one form, an electric deterrent device is provided, the electric deterrent device comprises an elongated flexible non-conductive core; and at least one conductive element attached to the elongated flexible non-conductive base by molding, heat-melting, clamps, glue, pins, tacs, nails, screws, sewing, staples, or any combination thereof. In some embodiments, the conductive element is co-molded to the core. In some embodiments, the clamps are attached to the sides of the core. In some embodiments, the pins, tacs, nails, screws, or staples do not penetrate entirely through the cross section of the core of the device.

In one form, an electric deterrent device is provided, the electric deterrent device comprises a flexible elongated non-conductive base; a first conductive element molded to the base; and a second conductive element molded to the base, wherein a first portion of the second conductive element is molded into the base, and a second portion of the second conductive element protrudes outward from an outer surface of the base.

In one form, an electric deterrent device is provided, the electric deterrent device comprises a flexible elongated non-conductive base; a first conductive element is at least partially located in a first channel in the outside surface of the base; and a second conductive element is at least partially located in a second channel in the outside surface of the base. In some embodiments, a first portion of the first conductive element is coupled to the first channel. In some embodiments, a second portion of the first conductive element protrudes outward from the outer surface of the base. In some embodiments, the first conductive element rests in the first channel. In some embodiments, the first conductive element is coupled to the channel by friction. In some embodiments, the first conductive element is coupled to the channel by an adhesive. In some embodiments, the first conductive element is coupled to the channel by heat melting of the base. In some embodiments, the first conductive element is coupled to the base by a fastener. In some embodiments, the first conductive element is coupled to the channel by at least one of clamps, locking cable ties, tying a string, staples, sewing, tacs, pins, screws, bolts, or other methods. In some embodiments, the channels are parallel to the longitudinal center of the base. In some embodiments, the channels are in a wrapped around the center axis of the base. In some embodiments, the channels are in helically wrapped around the center axis of the base.

In one form, an electric deterrent device is provided, the electric deterrent device comprising an elongated base having a cross section including an outer surface and an inner surface; a first conductive element extending perpendicular to the cross section along the outer surface; wherein the first conductive element is coupled to the outer surface of the base at a first connection point by a fastener; and wherein the fastener extends at least partially through the outer surface of the base. In some embodiments, the first conductive element is coupled to base by sewing. In some embodiments, the electric deterrent device further comprises a second conductive element.

In one form, an electric deterrent device is provided, the electric deterrent device comprising an elongated base having a cross section including an outer surface and an inner surface; a first conductive element extending perpendicular to the cross section along the outer surface; wherein the first conductive element is molded to the outer surface at a first connection point and extends from the outer surface through to a second connection point on the inner surface of the base.

In some embodiments, the outer surface isolates the first conductive element at the second connection point from an exterior. In some embodiments, the cross section of the elongated base has a slit in an outer surface of the elongated base such that the slit creates a flap in the outer surface of the elongated base where the flap helps insulate the first conductive element at the second connection point from moisture or bird excrement.

In some embodiments, wherein the elongated base further comprises at least one gap, into which at least one conductive element may extend; and at least one void into which no conductive elements extend. In some embodiments, the conductive element is made of a single strand. In some embodiments, the conductive element is made of multiple strands. In some embodiments, the conductive element is a wire in a wave or undulating shape with peaks and valleys.

In some embodiments, the conductive strands are twisted around the outer surface of the base. In some embodiments, the conductive strands are wrapped around the outer surface of the base. In some embodiments, wherein the base is a cylindrical shape, the conductive strands are wrapped in a helical shape around the outer surface of the base.

In one form, a method of producing an electric deterrent device is provided, the method comprising: pressing a first portion of a first conductive element into a non-conductive core during the molding process while the core material is still in its molten state; wherein a first portion of the first conductive element sets into the non-conductive core material, and a second portion of the first conductive element is exposed to an environment exterior to the non-conductive core. In some embodiments, the method further comprises pressing a first portion of a second conductive element into a non-conductive core during the molding process while the core material is still in its molten state; wherein a first portion of the second conductive element sets into the non-conductive core material, and a second portion of the second conductive element is exposed to an environment exterior to the non-conductive core. In some embodiments, the conductive elements are molded with the core such that the conductive elements are wrapped around the outer surface of the core.

In one form, a method of producing an electric deterrent device is provided, the method comprising: co-extruding a flexible elongated non-conductive core while feeding a first conductive element through an extruder with the non-conductive core such that at least a portion of the conductive element is positioned into the non-conductive core such the conductive element couples to the non-conductive core when the core cools; and wherein at least a portion of the conductive element is positioned such that it may be contacted by a bird landing on the device. In some embodiments, the conductive elements are wrapped helically around the outer surface of the core during the co-extrusion process.

In some embodiments, the conductive element is a stainless steel wire. In some embodiments, the wire is fed directly into the extrusion tool. In other embodiments, the wire is fed into the base after extrusion.

In one form, an electric deterrent device is provided, the electric deterrent device comprising: an elongated flexible non-conductive core; a conductive element co-molded with the elongated flexible non-conductive core so that portions of the conductive element extend upward from the surface of the elongated flexible non-conductive core.

In certain embodiments, the electric deterrent device further comprises a second conductive element coupled to the top surface of the top layer and extending parallel to the first conductive element. In another embodiment, an adhesive is disposed on a portion of conductive element that extends into the gap. In another embodiment, the first conductive element extends from the top surface of the top layer through the bottom surface of the top layer. In some embodiments, the first conductive element is located on the opposite side of the outer surface of the base from the second conductive element. In some embodiments, the conductive elements are located on the same side of the outer surface of the base.

In certain embodiments, the first conductive element is made of metal. In another embodiment, the first conductive element further comprises a braided wire. In yet another embodiment, the braided wire comprises some strands of a conductive material and other strands of a non-conductive material. In another embodiment, a gap at an end of the elongated base is sealed off from an exterior.

In one form, the present disclosure provides an electric deterrent device, comprising a first non-conductive piece having a top side and a bottom side a conductive element coupled to the first non-conductive piece; and a second non-conductive piece coupled to the first non-conductive piece wherein a second conductive element is coupled to the second non-conductive piece.

In certain embodiments, the first non-conductive piece is coupled to the second non-conductive piece by an adhesive. In another embodiment, the second non-conductive piece is coupled to the first non-conductive piece by interlocking In yet another embodiment, the first non-conductive piece and the second non-conductive piece comprise an interlocking shape; and wherein the interlocking shape is selected from the group of a T-shape, a stemmed inverted V-shape, a stemmed inverted U-shape, a stemmed circular shape, and an arrowhead shape.

In one form, the present disclosure provides an electric deterrent device, comprising an elongated base having a hollow interior space forming a top inside surface and a bottom inside surface; a first conductive element molded to a top of the elongated base wherein the first conductive element extends from a top outside surface of the elongated base through to the top inside surface of the elongated base; and a second conductive element molded to a top of the elongated base wherein the second conductive element extends from the top outside surface of the elongated base through to the top inside surface of the elongated base.

In one form, the present disclosure provides an electric deterrent device, wherein the electric deterrent device comprises an elongated base having a hollow interior space forming an inside surface, a first conductive element coupled to an outside surface of the elongated base wherein the first conductive element extends through the outside surface of the base to the inside surface, a second conductive element coupled to the outside surface of the elongated base wherein the second conductive element extends through the outside surface of the base to the inside surface.

In one form, the present disclosure provides a method of installing an electric deterrent device, comprising the steps of applying an adhesive between an outside surface of the electric deterrent device and an external surface; and pressing the electric deterrent device towards the external surface such that an anchor of the electric deterrent device is pressed into the adhesive. In some embodiments, the anchor may be an arc suppressor extending from the outside surface of the base. In some embodiments, the anchor may be ridges in the outside surface of the base. In some embodiments, the anchor extends from an inside surface of the base towards the center of the base. In some embodiments, the base contains a slit that creates a flap in the outside surface of the base.

In some embodiments, the pressing step further comprises pressing the electric deterrent device towards the external surface such that the adhesive pushes a flap on a side of the anchor upwards as the electric deterrent device is pressed into the adhesive. In another embodiment, the adhesive enters a space between the anchor and the flap as the electric deterrent device is pressed towards the external surface. In another embodiment, the adhesive is squeezed in a direction away from the anchor during the pressing step. In yet another embodiment, a portion of the anchor proximate to its bottom is thicker than a portion of the anchor further from its bottom. In certain embodiments, the anchor is an inverted T shape. In another embodiment, the anchor further comprises a ridge wherein the adhesive is disposed on a top surface of the ridge after the pressing step. In yet another embodiment, the first conductive element and a second conductive element coupled to the outside surface of the base are attachable respectively to the positive and negative terminals of a power source.

In one form, the present disclosure provides a method of installing an electric deterrent device, comprising the steps of applying an adhesive between an outside surface of the electric deterrent device and an external surface; and pressing the electric deterrent device towards the external surface such that an anchor of the electric deterrent device is pressed into the adhesive; wherein the electric deterrent device comprises an elongated circular core having a hollow interior space forming an inside surface, a first conductive element coupled to an outside surface of the elongated circular core that extends through to the inside surface, a second conductive element coupled to an outside of the elongated circular core that extends through to the inside surface, and the anchor protruding down from the inside surface.

In one form, the present disclosure provides a process for producing an electric deterrent device, the process comprising the steps of co-molding at least a pair of electrically conductive elements to an elongated core. In some embodiments, the core has an outside surface and an inside surface. In some embodiments, the process further comprises the step of creating a slit that extends from the outside surface to the inside surface such that it creates a flap in the elongated core.

In one form, the present disclosure provides a process for producing an electric deterrent device, the process comprising the steps of forming an elongated core having an outside surface and an inside surface; coupling a first conductive element to the outside surface; creating a slit that extends from the outside surface to the inside surface such that it creates a flap in the elongated core.

In one form, the present disclosure provides a process for producing an electric deterrent device, the process comprising the steps of coextruding at least a pair of elongated flexible conductive elements to an elongated core. In some embodiments, the core has an outside surface and an inside surface. In some embodiments, the process further comprises the step of creating a slit that extends from the outside surface to the inside surface such that it creates a flap in the elongated core. In some embodiments, the at least a pair of elongated flexible conductive elements extends at least partially through the inside surface of the core. In some embodiments, the process further includes folding the flap outward from the center of the core to obtain access to the inside surface of the core. In some embodiments, a paint, an adhesive, a foam, or an aerogel may be applied to the inside surface of the core.

In another embodiment, the process further comprises the step of sealing the slit. In another embodiment, the slit is sealed with an adhesive. In yet another embodiment, the cutting step is performed by a first blade creating the first slit; and a second blade creating a second slit. In another embodiment, the first slit and the second slit are made at the same time. In yet another embodiment, the first blade is parallel to the second blade. In another embodiment, the first blade and the second blade are angled towards each other. In some embodiments, the slit is created during the extrusion of the elongated base.

In one form, the present disclosure provides a process for producing an electric deterrent device, the process comprising the steps of forming a top layer of an elongated core, wherein the top layer has a bottom side and a top side; forming a bottom layer of an elongated core; fastening a first conductive element to the top side of the top layer at a first connection point, such that a fastener extends from the top side of the top layer to a second connection point on the bottom side of the top layer; and coupling the bottom layer to the bottom side of the top layer. In another embodiment, the bottom layer insulates the fastener at the second connection point from an exterior. In yet another embodiment, the bottom layer is coupled to the top layer by an adhesive. In another embodiment, the bottom layer is coupled to the top layer by stitching. In some embodiments, the forming steps are performed by extrusion. In some embodiments, the core has a hollow interior space.

In one form, the present disclosure provides a method of deterring birds, the method comprising suspending an electric deterrent device in a tree. In some embodiments, the electric deterrent device is suspended between the branches, limbs, or trunk of the tree. In some embodiments, the method further comprises the step of attaching the electric deterrent device to the tree. In some embodiments, the method further comprises the step of attaching the electric deterrent device to the tree by straping, binding, gluing, nailing, stapling, or otherwise coupling the electric deterrent device to a portion of the tree. In some embodiments, multiple electric deterrent devices may be used. In some embodiments, the electric deterrent devices are connected together using a connector between the conductive elements, the base, or both.

In one form, the present disclosure provides a method of deterring birds from a tree, the method comprising coupling an electric deterrent device to a tree.

In one form, the present disclosure provides an electric deterrent device, comprising an elongated flexible electrically non-conductive base strand; a first elongated flexible electrically conductive element wrapped around an axis of the base strand in a first rotational direction; a second elongated flexible electrically conductive element wrapped around the axis of the base strand in the first rotational direction; wherein the first elongated flexible electrically conductive element and the second elongated flexible electrically conductive element do not touch each other while wrapped around the base strand; a first elongated flexible electrically non-conductive element wrapped around the axis of the base strand in a second rotational direction; a second elongated flexible electrically non-conductive element wrapped around the axis of the base strand in the second rotational direction; wherein the first elongated flexible electrically non-conductive element and the second elongated flexible electrically non-conductive element do not touch each other while wrapped around the base strand.

In some embodiments, the first electrically conductive element is metal. In some embodiments, the conductive element is a conductive plastic. In some embodiments, the first electrically conductive element is coupled to conductive polymer. In other embodiments, the first electrically conductive element is conductive polymer.

In some embodiments, the first electrically conductive element is co-extruded with the elongated base. In another embodiment, the first electrically conductive element is comprised of at least one electrically conductive strand. In some embodiments, the first electrically non-conductive element is comprised of at least one electrically non-conductive strand.

In one form, the present disclosure provides an electric deterrent device, comprising an elongated flexible electrically non-conductive base strand; a first elongated flexible electrically conductive element coupled to the base strand; a second elongated flexible electrically conductive element coupled to the base strand; wherein the first elongated flexible electrically conductive element and the second elongated flexible electrically conductive element are wrapped around the base strand in a first rotational direction; wherein the first elongated flexible electrically conductive element and the second elongated flexible electrically conductive element do not contact each other while they are wrapped around the base strand; and wherein the first electrically conductive element is a conductive polymer.

In some embodiments, the electric deterrent device further comprises a first elongated flexible electrically non-conductive element wrapped around the axis of the base strand. In other embodiments, the first elongated flexible electrically non-conductive element is wrapped around the axis of the base strand in a second rotational direction. In some embodiments, the second elongated flexible electrically non-conductive element is wrapped around the axis of the base strand in the second rotational direction. In other embodiments, the first electrically conductive element is co-extruded with the elongated base. In some embodiments, the first electrically conductive element is comprised of at least one electrically conductive strand. In other embodiments, the first electrically non-conductive element is comprised of at least one electrically non-conductive strand.

In one form, the present disclosure provides an electric deterrent device, comprising an elongated flexible non-conductive base strand; a first elongated flexible electrically conductive element coupled to the base strand; a second elongated flexible electrically conductive element coupled to the base strand; wherein the first elongated flexible electrically conductive element and the second elongated flexible electrically conductive element are wrapped around the base strand; wherein the first elongated flexible electrically conductive element and the second elongated flexible electrically conductive element do not contact each other while they are wrapped around the base strand; and wherein the first electrically conductive element is co-extruded with the base strand.

In some embodiments, the first electrically conductive element is made of metal. In some embodiments, the first electrically conductive element is coupled to conductive polymer. In other embodiments, the first electrically conductive element is made of conductive polymer. In another embodiment, the first electrically conductive element is comprised of at least one electrically conductive strand. In some embodiments, the electric deterrent device further comprises a first elongated flexible electrically non-conductive element wrapped around the axis of the base strand.

These and other objects, features, aspects, and advantages of the present patent document will become better understood with reference to the following description and accompanying drawings.

### BRIEF DESCRIPTION OF THE DRAWINGS

FIG. 1 illustrates a side view of one preferred embodiment of the present patent document.

FIG. 2 illustrates a vertical cross sectional view along the line I-I of the preferred embodiment of the electric deterrent device of FIG. 1.

FIG. 3 illustrates a vertical cross sectional view of one embodiment of an electric deterrent device, where conductive elements are embedded in the outside surface of the base such that a first portion of each conductive element is disposed below the surface of the base.

FIG. 4 illustrates a vertical cross sectional view of an alternative embodiment of an electric deterrent device of the present patent document, where the base is shown as a solid cylindrical shape with no void or hollow interior space.

FIG. 5 illustrates a side view of an alternative embodiment of an electric deterrent device of the present patent document, where the electric deterrent device is a rope.

FIG. 6 illustrates a vertical cross sectional view along the line II-II of the embodiment of the electric deterrent device of FIG. 5.

FIG. 7 illustrates a vertical cross sectional view of an alternative embodiment of an electric deterrent device of the present patent document, where the inner strands that make up the core of the rope are non-conductive.

FIG. 8 illustrates yet another embodiment of an electric deterrent device of the present patent document, where the device has a hollow tube core, surrounded on its outer surface by multiple conductive strands and multiple non-conductive strands.

FIG. 9 illustrates a vertical cross sectional view of an alternative embodiment of an electric deterrent device of the present patent document, where the conductive elements are wrapped around a rope, where the rope is comprised of non-conductive base strands.

FIG. 10 illustrates a vertical cross sectional view of an alternative embodiment of an electric deterrent device of the present patent document, where there are four conductive elements wrapped around a non-conductive rope base made of four non-conductive base strands.

FIG. 11 illustrates a cross sectional view of another embodiment of an electric deterrent device of the present patent document, where there are two conductive elements wrapped around a non-conductive rope base made of six non-conductive base strands.

FIG. 12 illustrates a side view of an alternative embodiment of an electric deterrent device of the present patent document, where the conductive elements extend along the length of the elongated base parallel to its longitudinal axis.

FIG. 13 illustrates a vertical cross sectional view of the embodiment of the electric deterrent device of FIG. 12.

FIG. 14 illustrates a vertical cross sectional view of an alternative embodiment of an electric deterrent device of the present patent document, where the conductive elements are embedded into the base and extend along the length of the elongated base parallel to its longitudinal axis.

FIG. 15 illustrates a vertical cross sectional view of an alternative embodiment of an electric deterrent device of the present patent document, where the conductive elements are disposed on the top of the outer surface of the base.

FIG. 16 illustrates a vertical cross sectional view of an alternative embodiment of an electric deterrent device of the present patent document, where there are four conductive elements located on the outer surface of the base, and there are multiple voids in the base.

FIG. 17 illustrates a vertical cross sectional view of an alternative embodiment of an electric deterrent device of the present patent document, where the device is comprised of two conductive strands and five non-conductive strands extending parallel to each other in the longitudinal direction.

FIG. 18 illustrates a vertical cross sectional view of an alternative embodiment of an electric deterrent device of the present patent document, where the device is comprised of two conductive strands and four non-conductive strands extending parallel to each other in the longitudinal direction.

FIG. 19 illustrates a vertical cross sectional view of an alternative embodiment of an electric deterrent device of the present patent document, where the device is comprised of a star shaped base and six conductive strands extending parallel to each other in the axial direction.

FIG. 20 illustrates a vertical cross sectional view of an alternative embodiment of an electric deterrent device of the present patent document, where the conductive elements are embedded predominantly below the surface of the base, such that the outer surface of the device remains substantially round yet still exposing a portion of the conductive elements to the exterior of the device.

FIG. 21 illustrates a vertical cross sectional view of an alternative embodiment of an electric deterrent device of the present patent document, where the base is a rectangular shape, and the conductive elements are undulating wave shapes.

FIG. 22 illustrates a vertical cross sectional view of an alternative embodiment of an electric deterrent device of the present patent document, where the base has a slit that creates flaps in the outer surface of the base.

FIG. 23 illustrates a vertical cross sectional view of an alternative embodiment of an electric deterrent device of the present patent document, where the base has slits that creates flaps in the outer surface of the base.

FIG. 24 illustrates a vertical cross sectional view of an alternative embodiment of an electric deterrent device of the present patent document, where the outer surface of the base has ridges.

FIG. 25 illustrates a side view of an alternative embodiment of an electric deterrent device of the present patent document, where there are four conductive elements wrapped around the elongated base.

FIG. 26 illustrates a vertical cross sectional view along the line III-III of the device of FIG. 25.

FIG. 27 illustrates a side view of an alternative embodiment of a conductive element of the present patent document, where the conductive element is a rope of conductive strands wrapped around a non-conductive core.

FIG. 28 illustrates a vertical cross sectional view of the conductive element of FIG. 27.

FIG. 29 illustrates a vertical cross sectional view of an alternative embodiment of a conductive element of the present patent document, where the conductive element is a rope of conductive strands with no non-conductive elements.

FIG. 30 illustrates a side view of an alternative embodiment of an electric deterrent device of the present patent document, where the device has an elongated base with conductive elements wrapped around the base in one rotational direction (for example, a clockwise rotational direction), and non-conductive elements wrapped around the base in the opposite rotational direction (for example, a counterclockwise rotational direction) from the conductive elements.

FIG. 31 illustrates a perspective view of the embodiment in FIG. 30.

FIG. 32 illustrates a side view of an alternative embodiment of an electric deterrent device of the present patent document, where the non-conductive elements interlock with each other to hold the conductive elements the elongated base.

FIG. 33 illustrates an embodiment of a process 3300 for producing an electric deterrent device.

### DETAILED DESCRIPTION OF THE EMBODIMENTS

Reference will now be made to the drawings in which the various elements of the present disclosure will be given numerical designations and in which the present disclosure will be discussed so as to enable one skilled in the art to make and use the present disclosure. It is to be understood that the following description is only exemplary of the principles of the present disclosure, and should not be viewed as narrowing the claims. Additionally, it should be appreciated that the components of the individual embodiments discussed may be selectively combined in accordance with the teachings of the present disclosure. Furthermore, it should be appreciated that various embodiments will accomplish different objects of the present disclosure, and that some embodiments falling within the scope of the present disclosure may not accomplish all of the advantages or objects which other embodiments may achieve.

In some embodiments of the electric deterrent device, the conductive elements 130a and 130b are braided, such as the braided elements described in U.S. Pat. No. 7,481,021 titled “ELECTRIC DETERRENT DEVICE” which is herein incorporated by reference in its entirety, but they may also be knitted, mesh, interlocking loops, wires, rods, tubes, sheets, ropes, or other configurations. In some embodiments the conductive elements 130a and 130b may be conductive strips, wires, tubes, or sheets with no free spaces within. In some embodiments, the conductive elements 130a and 130b may contain free spaces within the conductive elements.

In some embodiments, the electric deterrent device of the present patent document contains at least one flap as described in U.S. patent application Ser. Nos. 13/533,846, 13/533,903, 13/533,923, and 13/774,241 all of which are titled “ANIMAL DETERRENT DEVICE WITH INSULATED FASTENERS” and all of which are herein incorporated by reference in their entirety.

In some embodiments, the electric deterrent device of the present patent document contains at least one void as described in U.S. Provisional Patent Application No. 61/816,122, titled “ELECTRIC DETERRENT DEVICE WITH VOIDS AND FLAPS” which is herein incorporated by reference in its entirety.

In some embodiments, the conductive elements may be undulated shapes molded to the base of the electric deterrent device as described in U.S. Provisional Patent Application No. 61/818,114, titled “FLEXIBLE ELECTRIC DETERRENT DEVICE WITH MOLDED CONDUCTORS” which is herein incorporated by reference in its entirety.

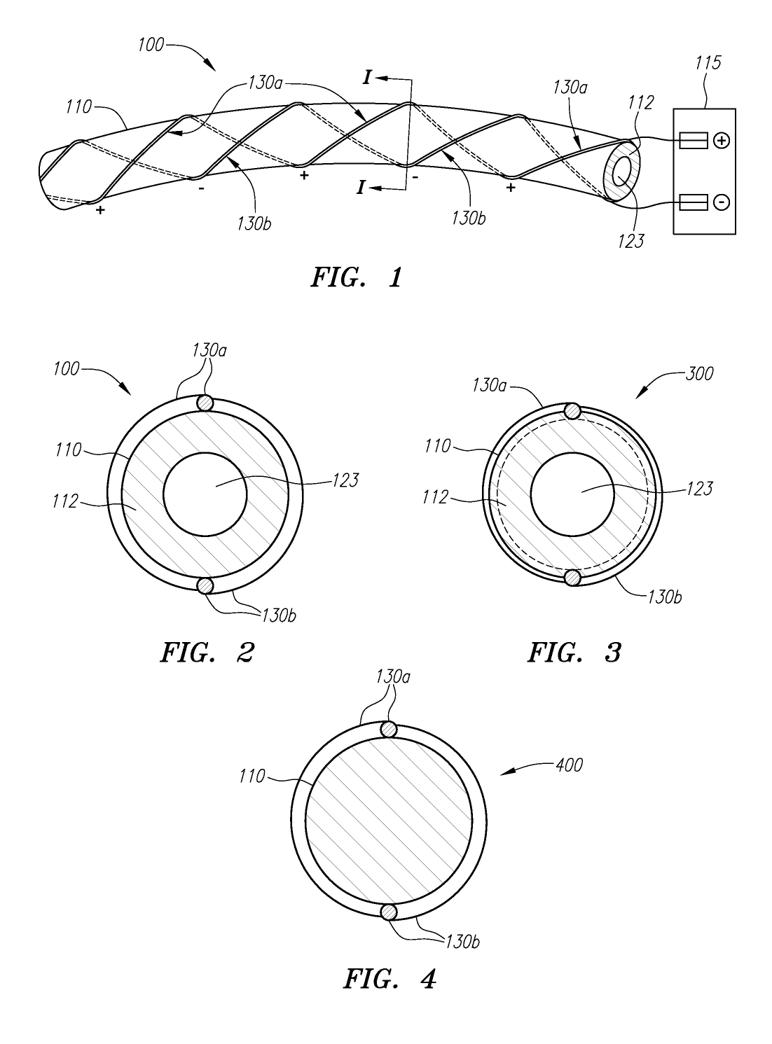

FIG. 1 illustrates a side view of a preferred embodiment of the present patent document. In the embodiment of FIG. 1, the electric deterrent device 100 includes an elongated base 110 and a pair of conductive elements 130a and 130b coupled to the base. In some embodiments, the electric deterrent device 100 includes an elongated base 110 and a pair of conductive elements 130a and 130b embedded into the base. In various embodiments, the elongated base 110 may be a variety of different shapes. It should be understood that only those specific elements of the shape of the elongated base 110 described in the claims limit the embodiments claimed.

In FIG. 1, the conductive elements 130a and 130b are each wrapped around the base such that the conductive elements 130a and 130b do not make contact with each other as they extend along the base. In some embodiments, the conductive elements 130a and 130b are helically wrapped around the base 110. In some embodiments, the conductive elements 130a and 130b are each wrapped around the base such that the conductive elements 130a and 130b do not make contact with each other as they extend along the base. In a preferred embodiment, the conductive elements 130a and 130b are parallel to each other. In the embodiment shown in FIG. 1, the conductive element 130a is connected to the positive terminal of a power source 115. In the embodiment shown in FIG. 1, the conductive element 130b is connected to the negative terminal of a power source 115. The elongated base 110 may be considered to have a radial direction that may extend from the center of interior space 123 through the outer layer 112 to the external surface of elongated base 110. The elongated base 110 may be considered to have an axial direction that may extend along the length of the elongated base 110 through the center of the ends of the elongated base 110.

In FIG. 1, the base is in the shape of a flexible elongated tube with an outer layer 112 and a void or interior space 123. In FIG. 1, the interior space 123 is open at each end of the device 100 such that the interior space 123 extends along the longitudinal length of the device 100. In other embodiments, the elongated base may be a solid piece without void or hollow interior space. In other embodiments, the elongated base may contain multiple voids extending along the length of the base.

In some embodiments, the conductive elements 130a and 130b are molded to the base during a co-extrusion process. In some embodiments, the base is made of flexible PVC. In the manufacturing process using extrusion other items or elements can be run with the extrusion of the elongated base, such as different types of plastics or even metals; this process is called co-extrusion.

In some embodiments, the conductive elements 130a and 130b may be braided, mesh, knitted, woven, interlocking loops, twisted ropes, tubes, ribbons, or other configurations. In some embodiments, the conductive element contains at least one free space through the conductive element. In other embodiments, the strands form free spaces within the conductive element, as for example free or open spaces in a braid, mesh, knitted, woven, rope, or interlocking loops configuration of the conductive element.

In one embodiment, the conductive element is one thin strand of stainless steel that wire is pre-formed into a zigzag pattern. In some embodiments, the wire is 0.020 inches in diameter. In other embodiments, the wire may be other diameters.

In some preferred methods of manufacturing the device, two rolls of the wire will feed into the extrusion machine (either directly into the extrusion tool, or immediately after it). The wire is pressed into the plastic as it feeds through a track. The result is that a bottom portion of the wire is buried into the plastic, while a top portion of the wire is exposed above the surface of the plastic.

In some embodiments, the elongated base 110 further comprises a bottom surface that may be attached to the exterior surface of the location from which the pests or birds are to be deterred. In some embodiments, the elongated base 110 further comprises a top surface. In some embodiments, the conductive elements 130a and 130b are separated by an arc suppressor 140 that runs along the outside surface of the base and between the conductive elements 130a and 130b. In the embodiment shown in FIG. 1, the elongated base 110 may further comprise an arc suppressor 140 located on the outside surface of the base 110 such that it is wrapped around the base 110 parallel to the conductive elements 130a and 130b. In the embodiment of FIG. 1, the shape of the elongated base is an elongated extrusion with a hollow cylindrical shape, but any shape of the elongated base 110 may be used. In the embodiment of FIG. 1, the elongated base 110 may also be referred to as a tube, a core, a strand, a cord, an elongated extrusion, or an extrusion, among others. In some embodiments, the elongated base 110 may either be made from a conductive element, or contain a conductive element. The electric deterrent device may be attached to the surface of the location from which the pests or birds are to be deterred by many different methods, including but not limited to staples, adhesive, nails, pins, tacs, adhesive, screws, nuts and bolts, or a combination thereof, as well as many others. In a preferred embodiment, glue is applied to a portion of the elongated base 110. In another embodiment, the glue is applied intermittently along the base 110. The elongated base 110 may be made by extrusion, casting, thermoforming, molding, or by any other method.

FIG. 2 illustrates a vertical cross sectional view along the line I-I of the preferred embodiment of the electric deterrent device 100 of FIG. 1. In FIG. 2, the conductive elements 130a and 130b are shown in a different enlarged size than the conductive elements 130a and 130b of FIG. 1 to better illustrate the conductive elements. In other embodiments, the conductive elements 130a and 130b may be any size. In FIG. 2, the conductive elements 130a and 130b are shown disposed on the outside surface of the base 110.

FIG. 3 illustrates a vertical cross sectional view of one embodiment of an electric deterrent device 300. In FIG. 3, the conductive elements 130a and 130b are embedded in the outside surface of the base 110 such that a first portion of each conductive element 130a and 130b is disposed below the surface of the base 110, as illustrated by the dotted lines in FIG. 3. In FIG. 3, a second portion of the conductive elements 130a and 130b is disposed above the outside surface of the base 110. In FIG. 3, the conductive elements 130a and 130b are wrapped around and embedded into the elongated base 110.

In some embodiments, the elongated base 110 may be formed with channels, notches, or grooves in the outside surface of the base 110. In some embodiments, the first conductive element 130a is disposed in the first channel, and the second conductive element 130b is disposed in the second channel. In some embodiments, the first conductive element 130a is coupled to the channel by friction. In some embodiments, the first conductive element 130a is coupled to the channel by an adhesive. In some embodiments, the first conductive element 130a is coupled to the channel by heat melting of the base 110. In some embodiments, the first conductive element 130a is coupled to the base 110 by a fastener 150a. In some embodiments, the first conductive element is coupled to the channel by at least one of clamps, locking cable ties, tying a string, staples, sewing, tacs, pins, screws, bolts, or other methods. In some embodiments, the channels are parallel to the longitudinal center of the base 110. In some embodiments, the channels are wrapped around the center axis of the base 110.

In some embodiments, the conductive elements may be a sine wave or undulating shape with peaks and valleys. In such embodiments, the peaks extend above the surface of the device, and the valleys extend below the surface or within the device. In some embodiments, the conductive elements are a square wave shape with flat topped peaks and flat bottomed valleys. In some embodiments, the conductive elements 130a and 130b may not extend higher than the arc suppressor 140.

FIG. 4 illustrates a vertical cross sectional view of an alternative embodiment of an electric deterrent device of the present patent document. In the embodiment of electric deterrent device 400 shown in FIG. 4, the base 110 is shown as a solid cylindrical shape with no void or hollow interior space. In some embodiments, the conductive elements 130a and 130b may extend higher than the arc suppressor 140.

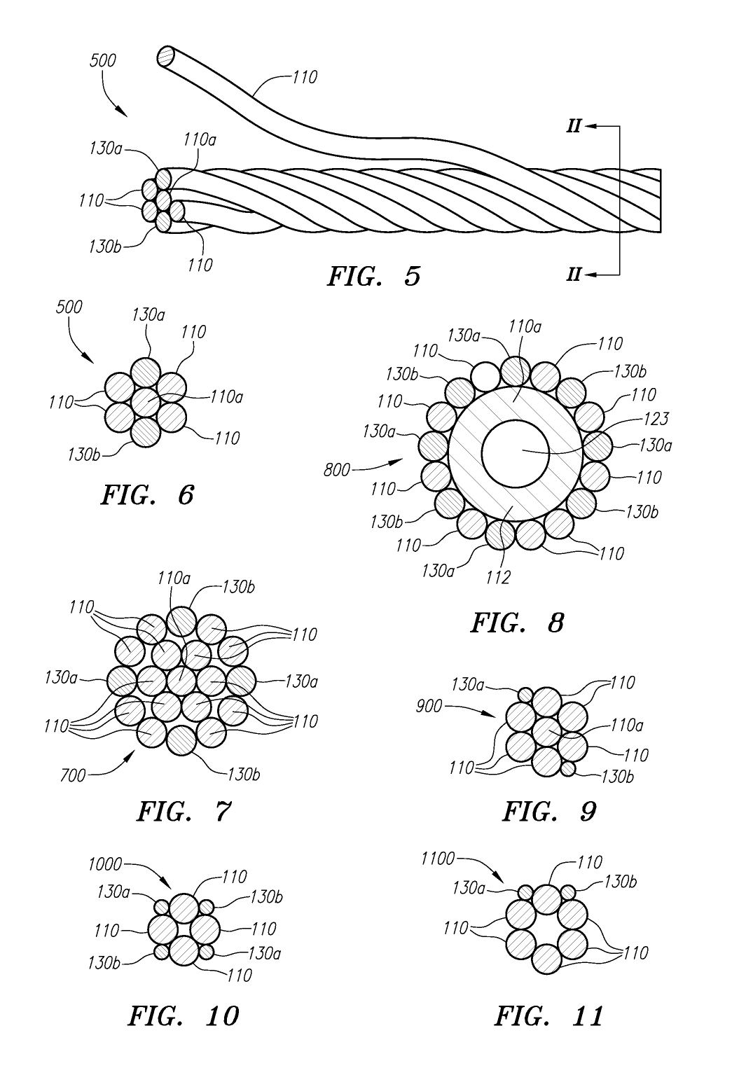

FIG. 5 illustrates a side view of an alternative embodiment of an electric deterrent device of the present patent document. In the embodiment of electric deterrent device 500 shown in FIG. 5, the device 500 is a rope shape with conductive elements 130a and 130b wrapped around a center non-conductive core strand 110a. In FIG. 5, the conductive elements 130a and 130b are conductive strands or wires. In the embodiment shown in FIG. 5, additional non-conductive strands 110 are wrapped around the non-conductive core 110a. In FIG. 5, the conductive elements 130a and 130b are wrapped around the center non-conductive core strand 110a. In the embodiment of FIG. 5, the device 500 is comprised of seven strands, where five strands are non-conductive, and two strands are electrically conductive. In other embodiments, other numbers of non-conductive or conductive strands may be used. In the embodiment of FIG. 5, the conductive elements 130a and 130b are positioned such that they do not touch each other as they are wrapped around the core 110a.

FIG. 6 illustrates a vertical cross sectional view along the line II-II of the embodiment of the electric deterrent device 500 of FIG. 5.

FIG. 7 illustrates a vertical cross sectional view of an alternative embodiment of an electric deterrent device of the present patent document. In the embodiment of electric deterrent device 700 shown in FIG. 7, the device 700 is a rope comprised of multiple strands, where the seven inner strands that make up the core are non-conductive. In the embodiment of FIG. 7, there are two conductive elements 130a positioned opposite one another in the cross sectional view, and two conductive elements 130b positioned opposite one another in the cross sectional view. In the embodiment of FIG. 7, the conductive elements 130a and 130b are positioned such that they do not touch each other. In this embodiment of FIG. 7, the conductive elements 130a are attachable to the positive terminal of a power source, and the conductive elements 130b are attachable to the negative terminal of a power source.

FIG. 8 illustrates yet another embodiment of an electric deterrent device of the present patent document. The embodiment of electric deterrent device 800 of FIG. 8 has a hollow tube core 110a, surrounded on its outer surface by a rope of multiple conductive strands and multiple non-conductive strands, such that no strand 130a touches a strand 130b. In this embodiment of FIG. 8, the conductive elements 130a are attachable to the positive terminal of a power source, and the conductive elements 130b are attachable to the negative terminal of a power source.

FIG. 9 illustrates a vertical cross sectional view of an alternative embodiment of an electric deterrent device of the present patent document. In the embodiment of electric deterrent device 900 shown in FIG. 9, the conductive elements 130a and 130b are wrapped around a rope, where the rope is comprised of non-conductive base strands 110 and core 110a.

FIG. 10 illustrates a vertical cross sectional view of an alternative embodiment of an electric deterrent device of the present patent document. In the embodiment of electric deterrent device 1000 shown in FIG. 10, there are four conductive elements (two conductive elements 130a and two conductive elements 130b) wrapped around a non-conductive rope base made of four non-conductive base strands 110. In this embodiment of FIG. 10, the conductive elements 130a are attachable to the positive terminal of a power source, and the conductive elements 130b are attachable to the negative terminal of a power source.

FIG. 11 illustrates a cross sectional view of another embodiment of an electric deterrent device of the present patent document. In electric deterrent device 1100 of FIG. 11, there are two conductive elements 130a and 130b wrapped around a non-conductive rope base made of six non-conductive base strands 110.

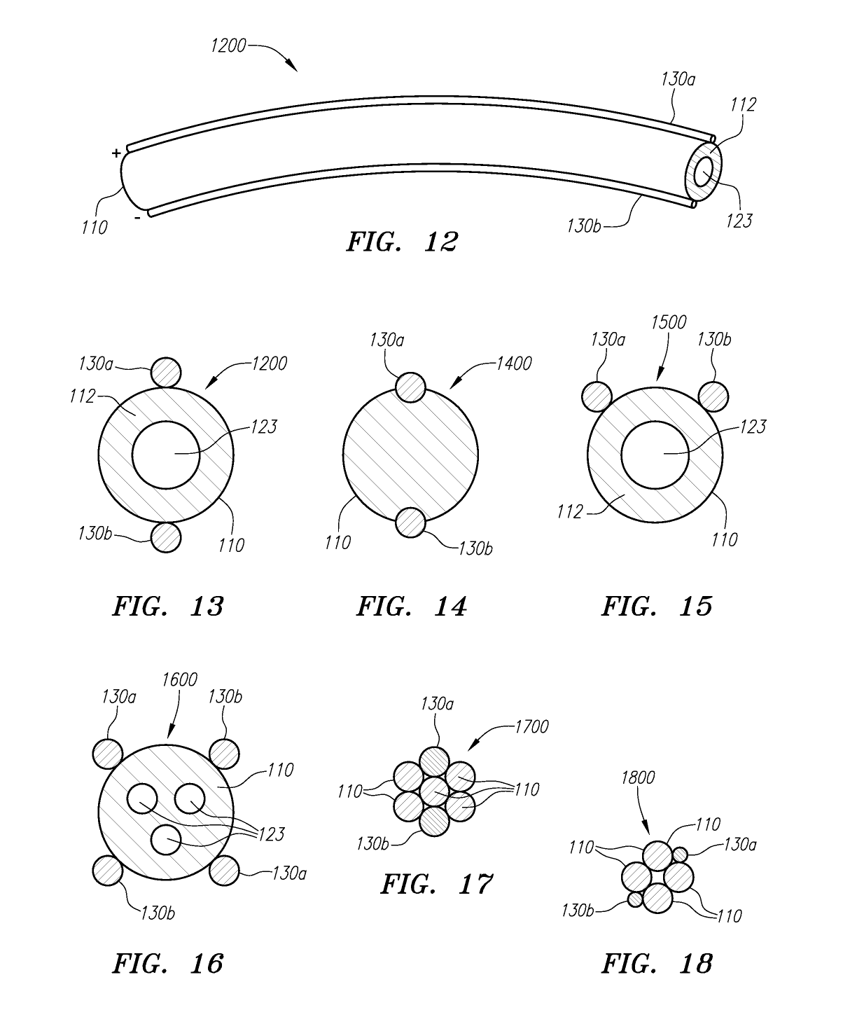

FIG. 12 illustrates a side view of an alternative embodiment of an electric deterrent device of the present patent document. In the embodiment of electric deterrent device 1200 shown in FIG. 12, the conductive elements 130a and 130b extend along the length of the elongated base 110 parallel to its longitudinal axis. In the device 1200, the conductive elements 130a and 130b are parallel to each other and to the void 123, where the void 123 extends from one end of the device to the opposite end.

FIG. 13 illustrates a vertical cross sectional view of the embodiment of the electric deterrent device 1200 of FIG. 12.

FIG. 14 illustrates a vertical cross sectional view of an alternative embodiment of an electric deterrent device of the present patent document. In the embodiment of electric deterrent device 1400 shown in FIG. 14, the conductive elements 130a and 130b are embedded into the base 110 and extend along the length of the elongated base 110 parallel to its longitudinal axis.

FIG. 15 illustrates a vertical cross sectional view of an alternative embodiment of an electric deterrent device of the present patent document. In the embodiment of electric deterrent device 1500 shown in FIG. 15, the conductive elements 130a and 130b are disposed on the top of the outer surface of the base 110.

FIG. 16 illustrates a vertical cross sectional view of an alternative embodiment of an electric deterrent device of the present patent document. In the embodiment of electric deterrent device 1600 shown in FIG. 16, there are four conductive elements located on the outer surface of the base 110, and there are multiple voids 123 in the base 110.

FIG. 17 illustrates a vertical cross sectional view of an alternative embodiment of an electric deterrent device of the present patent document. In the embodiment of electric deterrent device 1700 shown in FIG. 17, the device 1700 is comprised of two conductive strands and five non-conductive strands extending parallel to each other in the longitudinal direction.

FIG. 18 illustrates a vertical cross sectional view of an alternative embodiment of an electric deterrent device of the present patent document. In the embodiment of electric deterrent device 1800 shown in FIG. 18, the device 1700 is comprised of two conductive strands and four non-conductive strands extending parallel to each other in the longitudinal direction. In other embodiments, other numbers of non-conductive strands and conductive strands may be used.

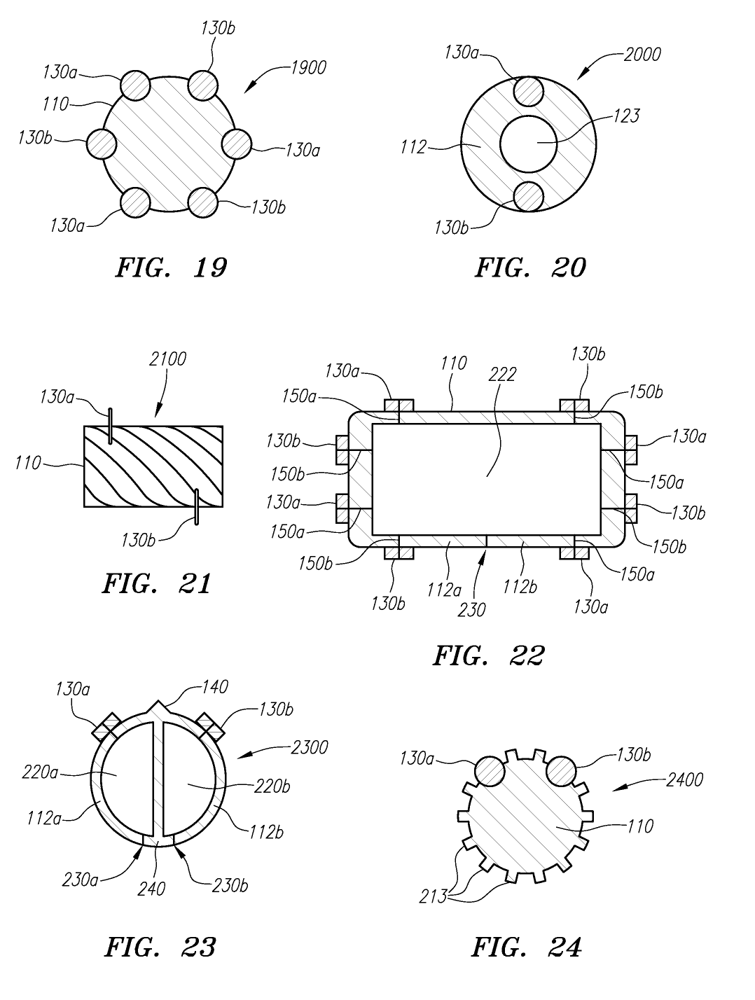

FIG. 19 illustrates a vertical cross sectional view of an alternative embodiment of an electric deterrent device of the present patent document. In the embodiment of electric deterrent device 1900 shown in FIG. 19, the device 1700 is comprised of a star shaped base 110 and six conductive strands extending parallel to each other in the axial direction.

FIG. 20 illustrates a vertical cross sectional view of an alternative embodiment of an electric deterrent device of the present patent document. In the embodiment of electric deterrent device 2000 shown in FIG. 20, the conductive elements 130a and 130b are embedded predominantly below the surface of the base 110, such that the outer surface of the device 2000 remains substantially round yet still exposing a portion of the conductive elements to the exterior of the device 2000.

FIG. 21 illustrates a vertical cross sectional view of an alternative embodiment of an electric deterrent device of the present patent document. In the embodiment of electric deterrent device 2100 shown in FIG. 21, base 110 is a rectangular shape. In other embodiments, the base 110 may be square, star, oval, irregular, or other shapes. In the embodiment of FIG. 21 the conductive elements 130a and 130b are co-extruded with the base 110. In FIG. 21, the conductive elements 130a and 130b are the shape of a sine wave or undulated shape, where the wave has peaks and valleys, where the valleys are embedded into the base 110, and the peaks extend from the outside surface of the base 110. In some embodiments, the conductive elements 130a and 130b as shown in FIG. 21 may be ribbons or sheets. In some embodiments, the conductive elements 130a and 130b as shown in FIG. 21 may be braided, mesh, knitted, interlocking loops, or other configurations.

FIG. 22 illustrates a vertical cross sectional view of an alternative embodiment of an electric deterrent device of the present patent document. In the embodiment of electric deterrent device 2200 shown in FIG. 22, the base 110 has a slit 230 that creates flaps 112a and 112b in the outer surface of the base 110. In FIG. 22, the conductive elements 130a and 130b are flat or rectangular shaped, and are coupled to the base 110 by fasteners 150a and 150b respectively. In the embodiment shown in FIG. 22, the edges of the gap 222 is made of a material flexible enough to allow the flaps 112a and 112b to be bent outward enough to expose the inside of the top layer of the elongated base 110.

In some embodiments, the device comprises a plurality of conductive elements. In some embodiments, the conductive element is made of metal. In other embodiments, the conductive element is made of multiple strands. In other embodiments, the conductive element is made of a single strand. In some embodiments, the conductive element is the shape of a flat ribbon. In some embodiments, the conductive element is a metal tape. In other embodiments, the conductive element is the shape of a tube. In some embodiments, the conductive element is made of one tube inside of another tube, or an inner tube and an outer tube configuration. In some embodiments, the conductive element is in the shape of a rope. In some embodiments, the conductive element is a twisted rope. In some embodiments, the conductive element is made of smooth strands. In other embodiments, the conductive element is made of a single strand interwoven with itself. In another embodiment, the strands of the conductive element are made of metal. In yet another embodiment, at least one strand of the first conductive element is made of metal, and at least one strand of the first conductive element is made of a non-conductive material. In other embodiments, some of the strands are made of metal and some are not. In some embodiments, the strands are constructed of stainless steel, copper, or zinc plated copper, or a combination thereof. In some embodiments, the conductive element may be a wire. In some embodiments, the conductive element may be a ribbon. In some embodiments, the conductive element may be a sheet. In some embodiments, each elongated flexible electrically conductive element has a plurality of free spaces along a length of the elongated flexible electrically conductive element and wherein, the free spaces form openings through the elongated flexible electrically conductive element wherein, the openings pass from a top of the electrically conductive element toward the base. In some embodiments, the elongated flexible electrically conductive elements are coupled to said flexible elongated non-conductive base by a fastener wherein, the fastener extends through at least one of the free spaces of the conductive element. In some embodiments, the fastener may be stitching, staples, pins, tacs, nails, glue, nuts and bolts, or any combination thereof.

In another embodiment, the conductive element is substantially flat in cross section. In yet another embodiment, the conductive element is substantially round in cross section. In another embodiment, the strands of the conductive element are woven loosely together. In yet another embodiment, the strands of the conductive element are woven tightly together.

In some embodiments, the conductive element is braided. In other embodiments, the conductive element is a mesh. In some embodiments, the conductive element is knitted. In other embodiments, the conductive element is made of interlocking loops. In some embodiments, the conductive element contains at least one free space through the conductive element. In other embodiments, the strands form free spaces within the conductive element, as for example free or open spaces in a braid, mesh, knitted, woven, or interlocking loops configuration of the conductive element.

In some embodiments, the strands are intermittently in contact along the length of the conductive element. In other embodiments, the strands are in repetitive intermittent contact for at least a portion of the length of the conductive element. In some embodiments, the strands may be interwoven to form the conductive element. In other embodiments, the strands may be interwoven together to form the conductive element. In some embodiments, the conductive element may be comprised of a single strand interwoven with itself.

FIG. 23 illustrates a vertical cross sectional view of an alternative embodiment of an electric deterrent device of the present patent document. In the embodiment of electric deterrent device 2300 shown in FIG. 23, the base 110 has slits 230a and 230b that creates flaps 112a and 112b in the outer surface of the base 110. In FIG. 22, the conductive elements 130a and 130b are separated by an arc suppressor 140. In the embodiment shown in FIG. 23, the edges of the gaps 220a and 220b are made of a material flexible enough to allow the flaps 112a and 112b to be bent outward enough to expose the inside of the top layer of the elongated base 110 to allow the conductive elements 130a and 130b to be fastened to the base 110 by fasteners 150a and 150b. The embodiment of FIG. 23 further comprises a glue anchor 240 that may be used to help attach the device 2300 to a surface on which it is to be attached such as a building or tree branch.

FIG. 24 illustrates a vertical cross sectional view of an alternative embodiment of an electric deterrent device of the present patent document. In the embodiment of electric deterrent device 2400 shown in FIG. 24, the outer surface of the base 110 has ridges 213 to increase the outer surface area of the elongated base 110. In some embodiments, the ridges 213 may help the device grip an exterior surface such as a tree branch, even if no adhesive is used to attach the device. In some embodiments, the ridges 213 extend axially along the length of the elongated base 110. In some embodiments, the ridges 213 may extend in other configurations such as zigzag patterns, or perpendicular to the conductive elements. An adhesive may be applied between the ridged outer surface and an exterior surface, such as a building or tree branch, such that the glue has a greater surface area to adhere to on the elongated base 110, than if there were a smooth base. In some embodiments, any number of ridges may be used. The electric deterrent device of FIG. 24 is shown with rectangular ridges 213, but rounded, angled, jagged, or other shapes may be used as long as they increase the surface area of the outer surface of the base 110. In some embodiments, the ridged pattern may be repeatable shapes. In other embodiments, the bottom surface may have non-repeating shapes. The ridged bottom surface may also be referred to as jagged or toothed. In other embodiments, the bottom surface may be corrugated or ribbed.

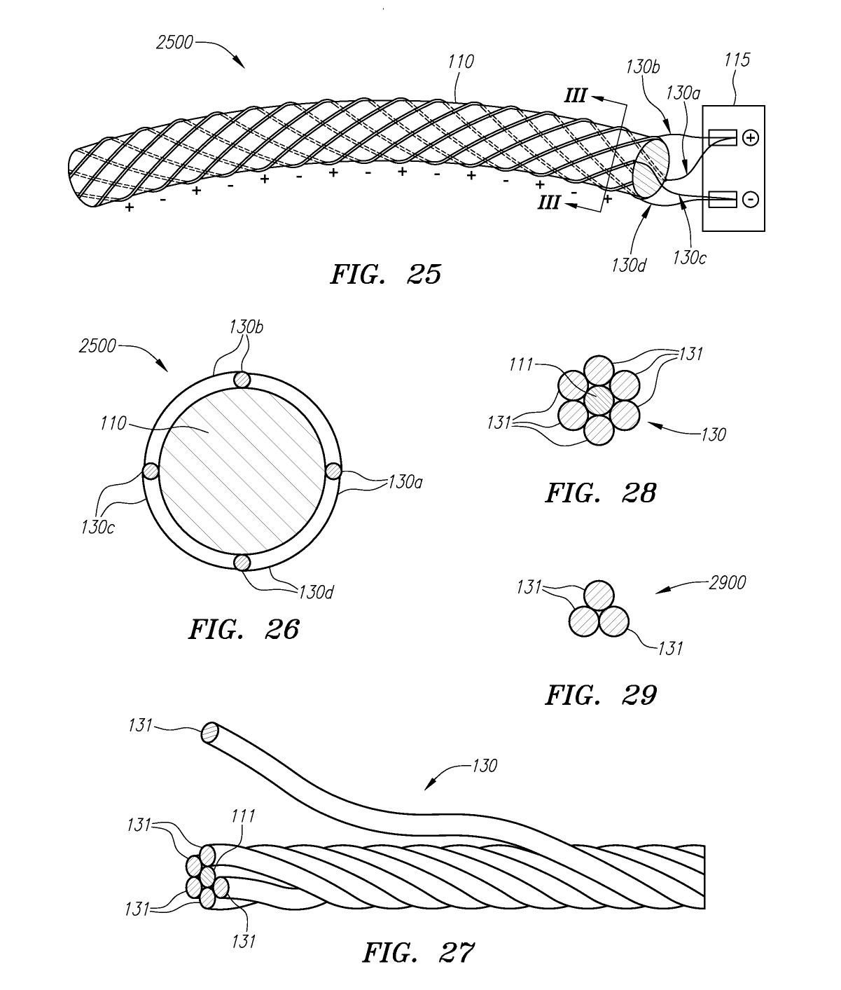

FIG. 25 illustrates a side view of an alternative embodiment of an electric deterrent device of the present patent document. In the embodiment of electric deterrent device 2500 shown in FIG. 25, there are four conductive elements wrapped around the elongated base 110 such that the conductive elements 130a do not touch conductive elements 130b.

FIG. 26 illustrates a vertical cross sectional view along the line III-III of the device 2500 of FIG. 25.

FIG. 27 illustrates a side view of an alternative embodiment of a conductive element of the present patent document. In the embodiment of conductive element 130 shown in FIG. 27, the conductive element 130 is a rope of conductive strands 131 wrapped around a non-conductive core 111.

FIG. 28 illustrates a vertical cross sectional view of the conductive element 130 of FIG. 27.

FIG. 29 illustrates a vertical cross sectional view of an alternative embodiment of a conductive element of the present patent document. In the embodiment of conductive element 2900 shown in FIG. 29, the conductive element 2900 is a rope of conductive strands 131 with no non-conductive elements.

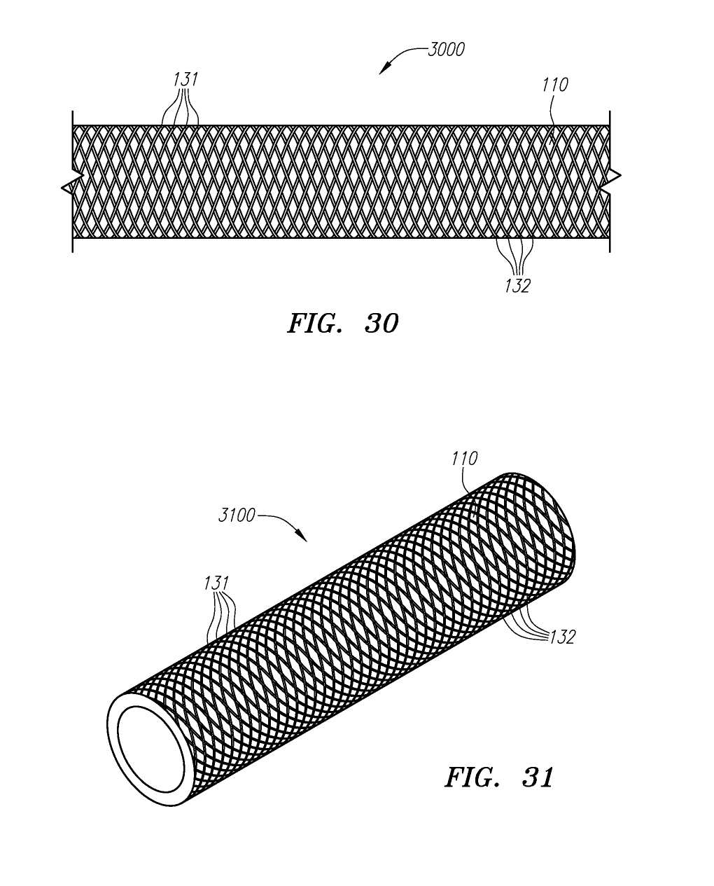

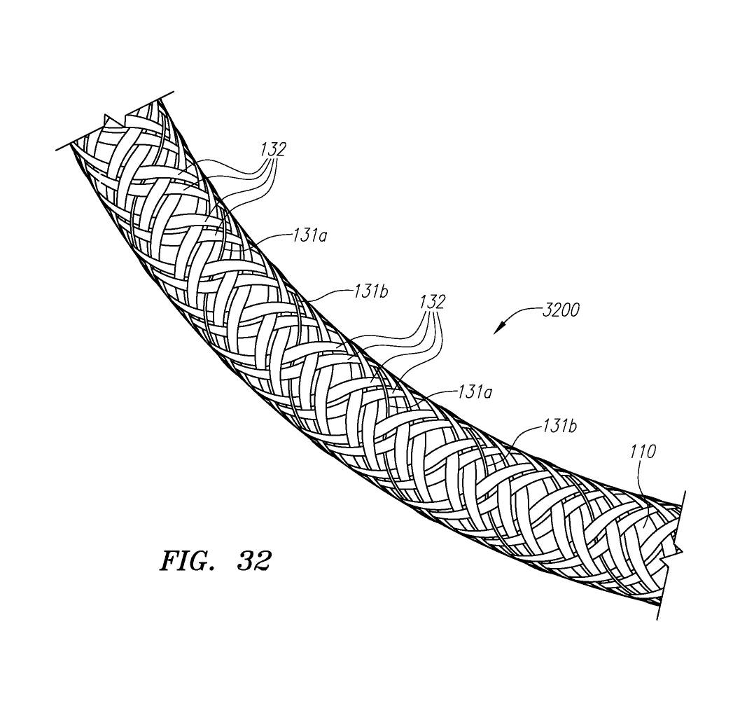

FIG. 30 illustrates a side view of an alternative embodiment of an electric deterrent device of the present patent document. In some embodiments, the device 3000 has an elongated base 110 with conductive elements 131 wrapped around the base 110 in one rotational direction (for example, a clockwise rotational direction), and non-conductive elements 132 wrapped around the base 110 in the opposite rotational direction (for example, a counterclockwise rotational direction) from the conductive elements 131. In other embodiments, the conductive elements 131 may be wrapped around the elongated base 110 in the same rotational direction as the non-conductive elements 132. In some embodiments, the conductive elements 131 may be wrapped around the elongated base 110 in the same rotational direction as the non-conductive elements 132, but at a different angle than the non-conductive elements 132. In some embodiments, as shown in FIG. 32, the non-conductive elements wrap in two opposing rotational directions while the conductive elements 131 wrap only in one rotational direction. In a preferred embodiment, two conductive strands 131 may be used (one conductive strand 131 coupled to a positive terminal of a power source, and the other conductive strand 131 coupled to the negative terminal of a power source). In some embodiments, any number of conductive elements 131 and non-conductive elements 132 may be used. In some embodiments, the conductive elements 131 alternate between positive and negative conductive elements. For example, in an embodiment where there are four conductive elements 131, they may be configured in the order positive, negative, positive, negative. In another embodiment with four conductive elements 131, they may be configured in the order positive, positive, negative, negative. In other embodiments, the number of conductive elements 131 may be three, six, eight, nine, twelve, or even other configurations. In an embodiment with three conductive elements 131, they may be configured in the order positive, positive, negative. In another embodiment, there may be only one conductive element 131 coupled to the positive terminal of a power source. In some embodiments, there may be any number of non-conductive elements 132. For example, in one embodiment there may be one non-conductive element 132 holding four conductive elements 131 to the elongated base 110. In another embodiment there may be four non-conductive elements 132 and four conductive elements 131. In some embodiments, a single conductive element 132 will alternate between being wrapped over one conductive element 131 and then underneath the next conductive element 131. In some embodiments, a non-conductive element 132 may be wrapped over one or more elements 131 before being wrapped underneath one or more conductive elements 131. A single conductive element 131 may be made of a single strand or multiple strands. A single non-conductive element 132 may be made of a single strand or multiple strands. In some embodiments, the conductive elements 131 may be made of metal such as iron, steel, stainless steel, copper, or zinc plated copper. In some embodiments, the non-conductive elements 132 may be made of plastic, polymer, vinyl, polyester, nylon, linen, twine, cotton, wool, or any other suitable material. In some embodiments, the non-conductive elements 132 may be made of a para-aramid synthetic fiber such as Kevlar®. In some embodiments, a conductive element 131 may be made up of any number of strands. In some embodiments, a non-conductive element 132 may be made up of any number of strands. In some embodiments, the non-conductive elements 132 may be made up of hundreds of strands.

FIG. 31 illustrates a perspective view of the embodiment in FIG. 30. FIG. 31 is shown with a hollow tube, but other configurations such as a solid tube with no hollow center may be used as well.

FIG. 32 illustrates a side view of an alternative embodiment of an electric deterrent device of the present patent document. In device 3200, the non-conductive elements 132 interlock with each other to hold the conductive element 131a and the conductive element 131b to the elongated base 110. In the embodiment shown in FIG. 32, the non-conductive elements 132 are made of multiple non-conductive strands. In other embodiments the non-conductive elements 132 may be made of a single strand. In the embodiment shown in FIG. 32, the conductive element 131 a is made of a single strand. In other embodiments, the conductive element 131a may be made of multiple strands. In the embodiment shown in FIG. 32, the conductive element 131b is made of a single strand. In other embodiments, the conductive element 131b may be made of multiple strands. In FIG. 32, the conductive elements 131a and 131b are round wires, however in other embodiments other configurations may be used, such as braided, mesh, tube, knitted, interlocking loops, or other configurations. In FIG. 32, the non-conductive elements 132 are flat ribbons containing multiple strands, however in other embodiments other configurations may be used, such as braids, mesh, tube, knitted, interlocking loops, a single strand, or other configurations. In some embodiments the elongated base 110 may be completely covered in non-conductive elements 132. In some embodiments, gaps may be left between non-conductive elements 132. In some embodiments, conductive elements 131 and non-conductive elements 132 may be any shape such as round, square, flat, hollow tube, angled, jagged, curved, or any other suitable shapes.

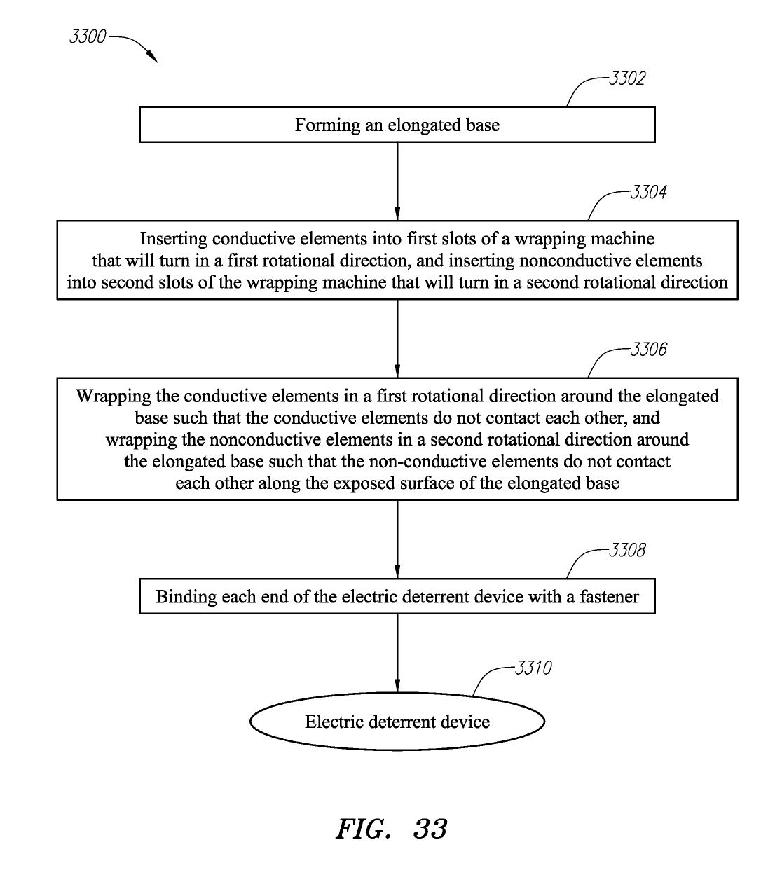

Referring now to FIG. 33, an embodiment of a process 3300 is shown. FIG. 33 illustrates an embodiment of a process 3300 for producing an electric deterrent device. Box 3302 comprises forming an elongated base 110. Box 3304 comprises inserting conductive elements 131 into the slots of a wrapping machine (not shown), and inserting non-conductive elements 132 into the slots of the wrapping machine. In some embodiments, the slots of a wrapping machine with conductive elements 131 will turn in a first rotational direction, and the slots of the wrapping machine with non-conductive elements 132 will turn in a second rotational direction. A wrapping machine may have numerous slots in which to place any number of conductive elements 131 or non-conductive elements 132. In some embodiments, the speed that the elongated base 110 runs through the wrapping machine can be increased so the angle of the conductive elements 131 and non-conductive elements 132 runs more along the axial direction of the elongated base 110. In some embodiments, gaps may be left in the setup configuration such that some slots may be left empty, providing for further spacing between either one or more of conductive elements 131 or non-conductive elements 132. In some embodiments, non-conductive elements 132 may be placed in some of the slots, which when the wrapping machine is engaged and rotating, the non-conductive elements 132 are then used to strap down the conductive elements 131. Box 3306 comprises wrapping the conductive elements 131 in a first rotational direction around the elongated base 110 such that the conductive elements 131 do not contact each other, and wrapping the non-conductive elements 132 in a second rotational direction around the elongated base 110 such that the non-conductive elements 132 do not contact each other along the exposed surface of the elongated base 110. The excess length of conductive elements 131 or excess length of non-conductive elements 132 may be cut to the required length either before or after the wrapping process. In optional box 3308, the ends of the electric deterrent device may be bound with a fastener to prevent unwrapping of the conductive elements 131 or non-conductive elements 132 if needed. Box 3310 results in the electric deterrent device. The fastener is preferably non-conductive material such as tape, a ring, a strap, glue, or anything that holds the conductive elements 131 and non-conductive elements 132 in place. In some embodiments, the conductive elements 131 and non-conductive elements 132 may be heat melted into the base 110. In some embodiments, the fastener may be at least one of clamps, locking cable ties, tying a string, staples, sewing, tacs, pins, screws, nuts and bolts, cloth, linen, twine, string, tape, adhesive, or any other suitable fastener. In some embodiments, the fastener may be made of a polymer, plastic, metal, vinyl, nylon, para-aramid synthetic fiber (such as Kevlar®), polyester, ceramic, wood, cotton, wool, glue, or any other suitable material.

In some embodiments, the conductive elements 131 may be intrinsically conducting polymers, such as for example, polyacetylene, polypyrrole, polyaniline, or their copolymers. The conductive polymer may either be used as the conductive element 131 or to partially or completely surround the conductive element 131 to provide protection against environmental elements such as water or bird excrement. In some embodiments, the conductive polymer may be co-molded or co-extruded with the elongated base 110 such that the conductive polymer is at least partially embedded in the elongated base 110, and at least another portion of the conductive polymer is disposed on the exterior of the elongated base 110.

In some embodiments, the device may further contain a void 123. In other embodiments the device may contain a plurality of voids 124. In some embodiments, a void may extend along the length of the elongated base in the axial direction. In other embodiments, a void 123 may divided into multiple voids by being either substantially or completely closed off at certain points, such as by the non-conductive material of the elongated base during manufacturing of the base, or by for example, a clamp, screw, nail, or weight placed on the device, possibly during use. In some embodiments, a void may be any size and shape. In some embodiments, a void may be as thin as a slit. In some embodiments, a void may be open at the axial ends of the elongated base. In other embodiments, a void may be closed at the axial ends of the elongated base. In some embodiments, a plurality of voids may extend perpendicular to the cross section of the elongated base. In some embodiments, voids may be entirely enclosed within the base. In other embodiments, voids may be partially enclosed within the base. In some embodiments, voids may connect to other voids. In some embodiments, the conductive elements may penetrate the voids. In other embodiments, the conductive elements do not penetrate any void 123 or voids 124. In some embodiments, the voids may be sealed off from an exterior. In some embodiments, the voids may be sealed by any means, including, but not limited to, by gluing, clamping, heat-melting, or any other method. A void 123 or a plurality of voids 124 may have benefits that include reducing the material used in the manufacturing of the elongated base of the device, thereby reducing cost and weight. The addition of a void 123 or voids 124 in the base may also increase flexibility of the device.

In some embodiments, a material may be added to the void 123 or the voids 124 to help maintain the shape of the device. In some embodiments, at least a portion of a void may include a low-density material, such as a foam or aerogel. In some embodiments where the conductive elements 130a and 130b penetrate a void, a material can be added to the void, such as an adhesive, a foam, or an aerogel, to further help prevent water, moisture, or bird excrement from contacting the bottom of the fasteners or the conductive elements.

Any dimensions cited are by way of illustration only. The dimensions may be varied in any fashion as appropriate to the application. As just one example, the dimensions may be varied to accommodate different size birds or other pests. Also, the length of the electric deterrent device 100 segment as illustrated is relatively short. However, the elongated base 110 may be constructed in any length, and is preferably constructed in as long a length as feasible so as to avoid inter-connecting segments of the electric deterrent device 100. For example, in one embodiment, the electric deterrent device 100 may be 100 feet long. In other embodiments, the electric deterrent device may be any length. However, inter-connecting segments of the electric deterrent device to form an elongated base of greater length than any individual segment may be used as well. In a preferred embodiment, the electric deterrent device 100 may be curved without harming its performance or life-expectancy. Accordingly, it may be rolled for shipment and storage, thus allowing for much longer single-formed pieces.

The electric deterrent device may include a center divider 240. In some embodiments, the center divider 240 may be referred to as an anchor. The anchor may also be referred to as a glue anchor, a glue lock, or glue spine. In some embodiments, the anchor may further comprise an area proximate to its bottom that has a greater width than other locations along its length. In some embodiments, the center divider 240 may be an inverted T-shape. The inverted T-shape operates as an anchor, creating a greater surface area for an adhesive to grip. In one embodiment, the anchor may be embedded into the adhesive. In another embodiment, the anchor further comprises a ridge wherein the adhesive is disposed on a top surface of the ridge after the pressing step. In one embodiment, during installation, the anchor embeds itself into the adhesive, and when the electric deterrent device is pressed toward an exterior surface, the remaining adhesive works its way towards the edges of the electric deterrent device, ensuring a tight grip. The adhesive may be applied to the bottom layer 112, or to the external surface. In a preferred embodiment, where the anchor is located in the center of the electric deterrent device, the adhesive may be applied to the center of the electric deterrent device. In some embodiments, the adhesive may be applied to other portions of the bottom of the device, such as in a zigzag pattern covering portions of the center and portions of areas under the flaps, or in patches along the axial length of the bottom of the device. In some embodiments, the adhesive may be glue. In some embodiments, the anchor may be located in the center of the electric deterrent device. In one embodiment, the anchor may have an upward facing surface substantially parallel to the bottom layer 112. In another embodiment, the anchor may be a shape with an upward facing surface that is angled. The anchor may be any shape such that the anchor has a greater surface area such that an adhesive can adhere to.

The electric deterrent device is preferably attached to the surface of the edge of the tree, tree branch, building, or place where the pests or birds are to be deterred. Attachment may be by any mechanical means such as screw, bolts, staples, nails, an adhesive such as glue, or any other attachment means, or any combination. In some embodiments, the electric deterrent device may be suspended between tree branches without any additional attachment mechanism. The elongated base 110 may be of any shape and size as dictated by the specific size and type of animal, bird or pest to be deterred, and the area to which the electric deterrent device is to be installed, so long as the two electrically conductive elements 130a and 130b are kept a sufficient distance apart so as to prevent unwanted short circuiting, and are not so far apart at to not be short-circuited when the intended-to-be deterred animal, pest or bird contacts the electric deterrent device. The elongated base 110 may be constructed of any material so long as there is sufficient non-conductive material immediately adjacent the conductive elements 130a and 130b so as to prevent unwanted short circuiting. In a preferred embodiment, the entire elongated base 110 is made of a single material, in this case extruded polyvinyl chloride that is extremely flexible, durable and UV resistant. The elongated base 110 may be constructed of any color so as to blend with the structure to which it will ultimately be attached. It is not necessary that the elongated base 110 be of unitary material and construction. In some embodiments, cellular, flex or rigid polyvinyl chloride may be used as a material for construction of the elongated base 110. In other embodiments, other possible materials for construction of the elongated base 110 may include, but are not limited to, neoprene, fluoroelastomer (available commercially under trademarks Vitron® and Flourel 8), silicone, natural rubber, buna N (nitrile), buna S (SBR), thermoplastic rubber, synthetic polyisoprene, EPDM and polyurethane.

Also, while stainless steel is preferred for the conductive elements, iron, steel, copper, and zinc plated copper are just some examples of many other conductive materials that could be substituted.

In some embodiments where the conductive elements are attached to the base by sewing, especially where the conductive elements 130a and 130b are braided, mesh, knitted, woven, or other configuration, while any suitably durable and string thread may be used in the sewing operation, 100% polyester has proven suitable. A single line of stitching illustrated as fasteners 150a and 150b down the longitudinal center of each conductive element 130a and 130b (best seen in FIG. 22) has proven sufficient, although many other sewing stitches, styles and placement would work as well. As shown in FIG. 22, the fasteners 150a and 150b could also represent staples or any other fastener.

In some embodiments, the ends of conductive elements 130a and 130b are attached to the terminals of a conventional power source. In other embodiments, the conductive elements 130a and 130b may be attached to the terminals of a conventional power source at locations other than at the ends of the conductive elements 130a and 130b through the use of clamps, clips, inserts or other similar ways of connecting conductive elements to a power source. A charge of approximately 800 volts alternating current, at low ampere (10 mA) or 7.5 KV, 3 amp direct current, has proven effective to deter birds. Larger voltages and amperes may be necessary for larger animals. If the desire was to execute the pest rather than simply deter, then the voltages and amperes would have to be increased accordingly, and the current bearing characteristics of the conductive elements 130a and 130b would have to be adjusted accordingly as well.

In some embodiments, multiple devices 100 may be placed in a parallel or substantially parallel configuration. In some embodiments, devices 100 placed in parallel configurations may be connected to each other. In some embodiments, devices 100 may be connected to each other by connectors contacting one or more of the conductive elements 130a and 130b. For example, in some embodiments, the conductive element 130a of one device 100, may be connected to the conductive element 130a of a second device 100. In some embodiments, the ends of one device 100 may be connected to a power source, while a second device 100 may be connected to the power source through a connector between the conductive elements of each device 100.

Although the embodiments have been described with reference to the drawings and specific examples, it will readily be appreciated by those skilled in the art that many modifications and adaptations of the apparatuses and processes described herein are possible without departure from the spirit and scope of the embodiments as claimed hereinafter. Thus, it is to be clearly understood that this description is made only by way of example and not as a limitation on the scope of the embodiments as claimed below.

What is claimed is:

1. An electric deterrent device, comprising:
an elongated flexible electrically non-conductive base strand;
a first elongated flexible electrically conductive element wrapped around an axis of the base strand in a first rotational direction;
a second elongated flexible electrically conductive element wrapped around the axis of the base strand in the first rotational direction;
wherein the first elongated flexible electrically conductive element and the second elongated flexible electrically conductive element do not touch each other while wrapped around the base strand;
a first elongated flexible electrically non-conductive element wrapped around the axis of the base strand in a second rotational direction;
a second elongated flexible electrically non-conductive element wrapped around the axis of the base strand in the second rotational direction;
wherein the first elongated flexible electrically non-conductive element and the second elongated flexible electrically non-conductive element do not touch each other while wrapped around the base strand.

2. The electric deterrent device of claim 1, wherein the first electrically conductive element is metal.

3. The electric deterrent device of claim 2, wherein the first electrically conductive element is coupled to conductive polymer.

4. The electric deterrent device of claim 1, wherein the first electrically conductive element is conductive polymer.

5. The electric deterrent device of claim 1, wherein the first electrically conductive element is co-extruded with the elongated base.

6. The electric deterrent device of claim 1, wherein the first electrically conductive element is comprised of at least one electrically conductive strand.

7. The electric deterrent device of claim 1, wherein the first electrically non-conductive element is comprised of at least one electrically non-conductive strand.

8. An electric deterrent device, comprising:
an elongated flexible electrically non-conductive base strand;
a first elongated flexible electrically conductive element coupled to the base strand;
a second elongated flexible electrically conductive element coupled to the base strand;
wherein the first elongated flexible electrically conductive element and the second elongated flexible electrically conductive element are wrapped around the base strand in a first rotational direction;
wherein the first elongated flexible electrically conductive element and the second elongated flexible electrically conductive element do not contact each other while they are wrapped around the base strand; and
wherein the first electrically conductive element is a conductive polymer.

9. The electric deterrent device of claim 8, further comprising a first elongated flexible electrically non-conductive element wrapped around the axis of the base strand.

10. The electric deterrent device of claim 9, wherein the first elongated flexible electrically non-conductive element is wrapped around the axis of the base strand in a second rotational direction.

11. The electric deterrent device of claim 10, wherein a second elongated flexible electrically non-conductive element is wrapped around the axis of the base strand in the second rotational direction.

12. The electric deterrent device of claim 8, wherein the first electrically conductive element is co-extruded with the elongated base.

13. The electric deterrent device of claim 8, wherein the first electrically conductive element is comprised of at least one electrically conductive strand.

14. The electric deterrent device of claim 9, wherein the first electrically non-conductive element is comprised of at least one electrically non-conductive strand.

15. An electric deterrent device, comprising:
an elongated flexible non-conductive base strand;
a first elongated flexible electrically conductive element coupled to the base strand;
a second elongated flexible electrically conductive element coupled to the base strand;
wherein the first elongated flexible electrically conductive element and the second elongated flexible electrically conductive element are wrapped around the base strand;
wherein the first elongated flexible electrically conductive element and the second elongated flexible electrically conductive element do not contact each other while they are wrapped around the base strand; and
wherein the first electrically conductive element is co-extruded with the base strand.

16. The electric deterrent device of claim 15, wherein the first electrically conductive element is metal.

17. The electric deterrent device of claim 6, wherein the first electrically conductive element is coupled to conductive polymer.

18. The electric deterrent device of claim 15, wherein the first electrically conductive element is conductive polymer.

19. The electric deterrent device of claim 15, wherein the first electrically conductive element is comprised of at least one electrically conductive strand.

20. The electric deterrent device of claim 15, further comprising a first elongated flexible electrically non-conductive element wrapped around the axis of the base strand.
